(19) United States
(12) Patent Application Publication
(10) Pub. No.: US 2022/0342398 A1
(43) Pub. Date: Oct. 27, 2022

(54) METHOD FOR SELF-LEARNING MANUFACTURING SCHEDULING FOR A FLEXIBLE MANUFACTURING SYSTEM BY USING A STATE MATRIX AND DEVICE

(71) Applicant: Siemens Aktiengesellschaft, München (DE)

(72) Inventors: Danielle Turner, Nürnberg (DE); Schirin Bär, Fürth (DE)

(21) Appl. No.: 17/642,307

(22) PCT Filed: Sep. 19, 2019
(86) PCT No.: PCT/EP2019/075168

§ 371 Date: Mar. 11, 2022

(51) Int. Cl. G05B 19/418

(52) U.S. Cl. CPC G05B 19/41865; G05B 2219/31264; G05B 2219/33056; G05B 2219/32301

(57) ABSTRACT

The method for self-learning manufacturing scheduling for a flexible manufacturing system (FMS) with processing entities that are interconnected through handling entities is disclosed. The manufacturing scheduling is learned by a reinforcement learning system on a model of the flexible manufacturing system. The model represents at least the behavior and the decision making of the flexible manufacturing system, and the model is transformed in a state matrix to simulate the state of the flexible manufacturing system. A self-learning system for online scheduling and resource allocation is also provided. The system is trained in a simulation and learns the best decision from a defined set of actions for many every situation within an FMS. A decision may be made in near real-time during a production process and the system finds the optimal way through the FMS for every product using different optimization goals.

The present patent document is a § 371 nationalization of PCT Application Serial No. PCT/EP2019/075168, filed Sep. 19, 2019, designating the United States, which is hereby incorporated by reference.

### TECHNICAL FIELD

The disclosure relates to methods, devices, and systems for self-learning manufacturing scheduling for a flexible manufacturing system used to produce a product.

### BACKGROUND

A flexible manufacturing system (FMS) is a manufacturing system in which there is some amount of flexibility that allows the system to react in case of changes, whether predicted or unpredicted.

Routing flexibility covers the system's ability to be changed to produce new product types, and to change the order of operations executed on a part. Machine flexibility is the ability to use multiple machines to perform the same operation on a part, as well as the system's ability to absorb large-scale changes, such as in volume, capacity, or capability.

Most FMS include three main systems. The work machines may be automated CNC machines that are connected by a material handling system to optimize parts flow and the central control computer which controls material movements and machine flow.

The main advantage of an FMS is its high flexibility in managing manufacturing resources like time and effort in order to manufacture a new product. The best application of an FMS is found in the production of small sets of products like those from a mass production.

As the trend moves to modular and Flexible Manufacturing Systems (FMS), offline scheduling is no longer the only measure that enables efficient product routing. Unexpected events, (e.g., failure of manufacturing modules, empty material stacks, or the reconfiguration of the FMS), are taken into consideration. Therefore, it is helpful to have an (e.g., additional) online scheduling and resource allocation system.

A second problem is the high engineering effort of state-of-the-art scheduling systems, like a product routing system as MES. Furthermore, these solutions are static. A self-learning product routing system would reduce the engineering effort, as the system learns the decision for every situation by itself in a simulation until it is applied at runtime and may be retrained for changes or adaptions of the FMS.

Manufacturing Execution Systems (MES) are used for product planning and scheduling, but it is an extreme high engineering effort to implement these mostly customer specific systems. The planning and scheduling part of an MES may be replaced by the online scheduling and allocation system.

Additionally, there are a few concepts of self-learning product routing systems, but with high calculation expenses (e.g., calculating the best decision online during the product is waiting for the answer).

Descriptions of those concepts may be found in the following disclosures:
Di Caro, G., and Dorigo, M, “Antnet distributed stigmergic control for communications networks,” Journal of Artificial Intelligence Research 9:317-365 (1998). Dorigo, M., and Stützle, T. 2004. Ant Colony Optimization. The MIT Press.
Sallez, Y.; Berger, T.; and Trentesaux, D, “A stigmergic approach for dynamic routing of active products in fms,” Computers in Industry 60:204-216 (2009).
Pach, C.; Berger, T.; Bonte, T.; and Trentesaux, D, “Orca-fms: a dynamic architecture for the optimized and reactive control of flexible manufacturing scheduling,” Computers in Industry 65:706-720 (2014).

Another approach is a Multi Agent System, where there is a central entity controlling the bidding of the agents, so the agents communicate with this entity, which is described in Frankovič, B., and Budinská, I, “Advantages and disadvantages of heuristic and multi agents approaches to the solution of scheduling problem,” Proceedings of the Conference IFAC Control Systems Design, Bratislava, Slovak Rep.: IFAC Proceeding Volumes 60, Issue 13 (2000), or Leitão, P., and Rodrigues, N, “Multi-agent system for on-demand production integrating production and quality control”. HoloMAS 2011, LNAI 6867: 84-93 (2011).

Reinforcement learning is a machine learning method, training agents by using a system of reward and punishment.

A reinforcement learning algorithm, or agent, may learn by interacting with its environment. The agent receives rewards by performing correctly and penalties for performing incorrectly. The agent learns without intervention from a human by maximizing its reward and minimizing its penalty.

### SUMMARY

It is the purpose of the disclosure to offer a solution for the above discussed problems for product planning and scheduling of am FMS.

The scope of the present disclosure is defined solely by the appended claims and is not affected to any degree by the statements within this summary. The present embodiments may obviate one or more of the drawbacks or limitations in the related art.

The method for self-learning manufacturing scheduling for a flexible manufacturing system with processing entities that are interconnected through handling entities include the following acts: the manufacturing scheduling is learned by a reinforcement learning system on a model of the flexible manufacturing system; the model represents at least the behavior and the decision making of the flexible manufacturing system; and the model is transformed in a state matrix to simulate the state of the flexible manufacturing system.

Further, the reinforcement learning system for self-learning manufacturing scheduling for a flexible manufacturing system that is used to produce at least a product is disclosed. The manufacturing system includes processing entities interconnected through handling entities, wherein an input of the learning process includes a model of the flexible manufacturing system. The model represents at least the behavior and the decision making of the flexible manufacturing system, and the model is realized as a state matrix, according to one of the methods disclosed herein.

The proposed solution includes a self-learning system for online scheduling and resource allocation, which is trained in a simulation and learns the best decision from a defined set of actions for many every situation within an FMS. For unseen situation, the solution is approached when Neural Networks are used. When applying this system, a decision may be made in near real-time during the production process and the system finds the optimal way through the FMS for every product using different optimization goals. It is especially good in the use of manufacturing systems with routing flexibility and to automatically route the product through the plant and allocate a suitable machine or manufacturing module.

### BRIEF DESCRIPTION OF THE DRAWINGS

In the following, the disclosure is illustrated in the following embodiments.

FIG. 1 depicts an overview of the training concept of the RL agent in a virtual level and application of the trained model at the physical level.

FIG. 2 depicts a representation of the state and behavior of an FMS in the virtual level and as a matrix.

FIG. 3 depicts a possible draft of a GUI to schematically design the FMS.

### DETAILED DESCRIPTION

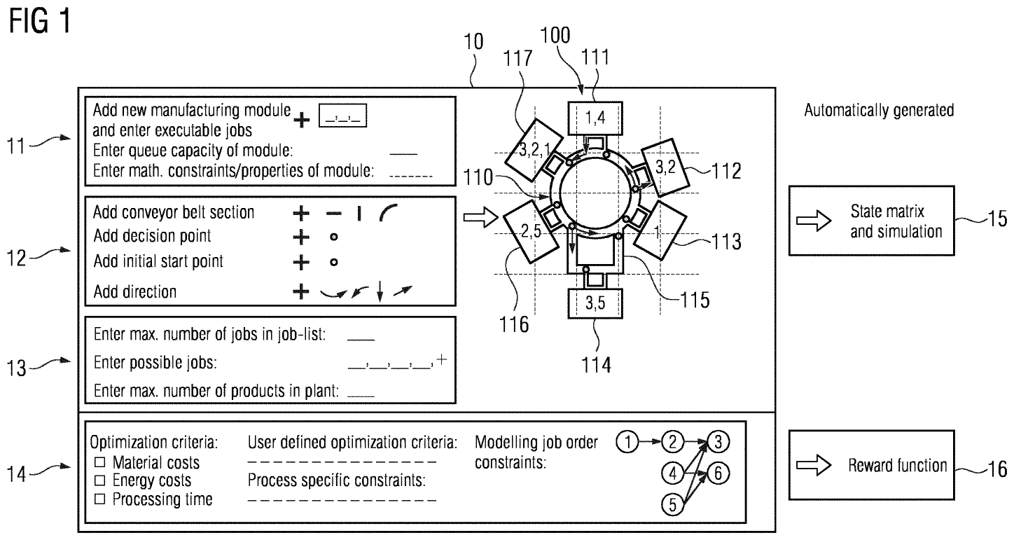

In FIG. 1, the training concept of the RL agent 300 in a virtual level (that means a simulation) at the physical level (real FMS 500) is shown. Agent 300 is trained against simulation of the FMS 100. The trained model 400 is later applied as controlled policy 600 of the physical level 500.

On the top right a schematic representation 100 of the real FMS 500 is shown, with all the processing entities M1, . . . , M6 and handling entities C0, . . . , C6. The processing entities have functionalities/actions F1, . . . , F3 realized, (e.g., machining, drilling, etc.).

After choosing an action from a finite set of actions 302, beginning by making randomized choices, the environment is updated, and the RL agent observes 303 the new state, State, and reward as an evaluation of its action. The goal of the RL agent is to maximize the long-term discounted rewards 301 by finding the best control policy.

As RL technology, we may use SARSA, DQN, etc., which in FIG. 1 may be found as Deep Neural Net DNN, 104.

As modules may be replaced by various manufacturing processes, this concept is transferable to any intra-plant logistics application.

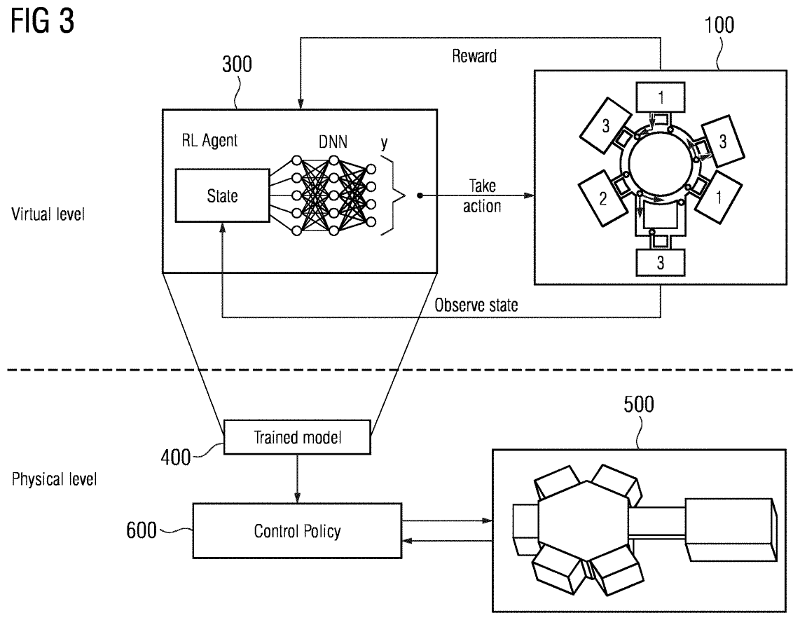

If, in some cases, there is a situation which is not known to the system (e.g., when there is a new manufacturing module), the system is able to explore the actions in this situation and learn online how the actions perform. So, the system learns the best actions for unknown situations online, though it will likely choose suboptimal decisions in the beginning. Alternatively, there is the possibility to train the system in the training setup again with the adapted plant topology by using the GUI, which is more deeply described later in FIG. 3.

An important step is the representation of the FMS 500 as a state matrix 200 as a simulation of the FMS. The generation of the state matrix from a representation 100 of the FMS may happen automatically.

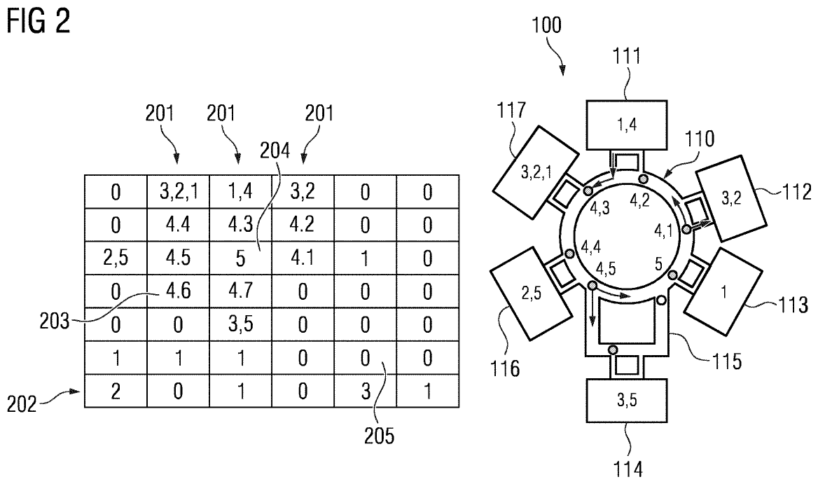

The state matrix is generated automatically after designing the schematic of the FMS, e. g. with the help of the GUI 10 in FIG. 3. An example of the state matrix is shown in FIG. 2 with the belonging FMS. With this shape of the matrix, it is easy for the user to understand the agent's behavior instead of trusting in a black box.

In FIG. 2, there is a representation 100 of the FMS on the right side and on the left side the corresponding state matrix 200 of the FMS.

Each processing unit M1, . . . , M6 has a corresponding field in the state matrix, the arrangement of the concerned fields of the state matrix according to the topology of the FMS. The content of the particular field shows information about the functions (F1, F2, F3) of the particular processing entity.

Further the handling units (C0, . . . , C6) are depicted in own fields, and the decision points D, with the respective waiting products 1, . . . , 4 may be found in the matrix in the last line 202. The line before the last line JL shows the progress of the processing job, e. g. which machines M1, . . . , M6 are still needed.

The handling units, for example conveyor belts (C0, . . . , C6) are ordered in a similar way to the real plant topology and the production modules/processing units (M1, . . . , M6) around them. The production modules contain further information on the jobs they are able to execute, or attributes that the plant operator wants to depict like production time, quality, or energy efficiency, just to mention a few of them. The controlled product 204 is marked by a specific number, in this example by number 5 and is updated to the decision-making points 4.1, 4.2, . . . , it is currently positioned.

The second to last row represents the job-list JL and the last row 202 contents the number of products currently waiting in the queue of the specific modules to consider other products in the manufacturing process. Alternatively, a list with product IDs may be stored in said matrix field.

The state matrix is in parallel used as simulation as the product moves to the next position in the conveyor belt, depending on which decision was chosen. If the product steps into a module, it is not depicted in the simulation as the simulation is only updated at the next decision-making point with the updated job-list. The initial state may be characterized by a full job-list and a defined product location, and the termination state may be defined as a fulfilled job-list, that means all fields have the value “0” (empty)—no products waiting.

For every module or machine of the plant, there is one place generated in the matrix. This is done module by module and the matrix is built up in the same way, as the modules are ordered in the plant topology. For every decision-making point of the transport (e.g., conveyor section between the modules), there is also a place in the matrix generated on a place, which is adjacent to the two connecting modules. The matrix is built up automatically and rule-based in the same order as the plant topology. For example, for the decision to generate a new row in the matrix, the grid in the GUI may help. The grid may help to locate the modules and conveyor sections and to find the according place in the matrix then.

After the state matrix and the simulation are created automatically, the system may be trained on these requirements. A Reinforcement Learning (RL) agent is used to train the system. It is not a Multi Agent System (MAS), so there is no need for the products to communicate with each other as the state of the plant includes the information of the queue length of the modules. The fact that with RL no labelled data is needed makes this approach very attractive for plant operators, who may sometimes struggle with the task of generating labelled data.

In one embodiment, a GUI may be used, where the plant operator depicts the plant schematically and with very little engineering effort. An example GUI is shown in FIG. 3. There are boxes for modular and static production modules and thin boxes which represent conveyor belt sections. Decision making points D have to be placed at desired positions. Behind the GUI there are fixed, and generic rules implemented, such as the fact that at the decision making points a decision needs to be made and the products may move on the conveyor belt from one decision making point to the next one after a decision is made.

The processing units may be defined via box 11 of the GUI. The maximum number of products at one time in the plant, the maximum number of jobs in one job-list, and all possible jobs of the job-list, as well as the properties of the modules (including available executable jobs or operations or maximum queue length) may be set in the GUI easily, see box 12 and 13.

Actions may be set as well, but at a decision point with various directions an action on default is choosing direction. When there is a decision point in front of a module and there is no conveyor belt leading into the module, the action “step into” may be set. With this schematic drawing of the plant 100 and with the fixed knowledge of the meaning of the input, it is possible to automatically generate a simple simulation of the plant that is sufficient for training with the products moving from one decision point to the next one.

Furthermore, the representation of the state of the FMS may directly and automatically be depicted as a state matrix 15 as the system generating the state matrix has the knowledge about the meaning of the input of the GUI. If there is additional information the plant operator wants to depict in the simulation or state matrix, there is the possibility to code this information directly.

An alternative is a descriptive (OPC UA) information model, which describes the plant topology, etc., which then may be read by a specific (OPC UA) Client. The Client may then build a simulation and a state matrix.

The reward function 16 values the action the system chooses, in this case the route that the product takes as well as how the product complied with given constraints on its route and check at each time step whether the action was useful. Therefore, the reward function contains these process specific constraints, local optimization goals, and global optimization goals, which all may be defined via box 14. Also, the job order constraints (e.g., which job is done first, second, etc.) may be set 17.

The reward function is automatically generated, as it is a mathematical formulation of optimization goals to be considered.

The user defines the importance of the optimization goals (for example, in the GUI 14) for instance:

5×Production time, 2×quality, 1×energy efficiency

This information will directly be translated in the mathematical description of the reward function:

0.625 Production time+0.25×quality+0.125×time energy

Additionally, the reward function includes optimization goals the system may consider during the manufacturing process. These goals may include makespan, processing time, material costs, production costs, energy demand, and quality. It is the plant operator's task to set process specific constraints and optimization goals in the GUI. It is also possible to consider combined and weighted optimization goals, depending on the plant operator's desire.

In the runtime, the received reward may be compared with the expected reward for further analysis or decisions to train the model again or fine tune it.

In summary, the disclosure provides a RL agent that is trained in a virtual environment (e.g., generated simulation) and learns how to react in every possible situation that it has seen. After choosing an action from a finite set of actions, beginning by making randomized choices, the environment is updated, and the RL agent observes the new state and reward as an evaluation of its action. The goal of the RL agent is to maximize the long-term discounted rewards by finding the best control policy.

During training, the RL agents sees many possible situations (e.g., very high state space) multiple times until it knows the optimal action. For every optimization goal, a different RL agent is trained.

In the first training act, the RL agent is trained to control the product in a way that it is manufactured according to its optimization goal. Other products in the manufacturing process are controlled by a fixed policy.

In the second training act, different RL agents are trained during the same manufacturing process and simulation. This is to adjust the RL agents to each other and respect other agent's decisions and to react on them. When the RL agents give satisfactory results, the models trained in the virtual environment are then transferred to the physical level of the plant, where they are applied as control policy. Depending on the defined optimization goals for each product, the appropriate control policy is used to control the product routing and therefore the manufacturing. This enables the manufacturing of products with lot size one and a specific optimization goal, such as high energy efficiency or low material costs, at the same time in one FRMS. With the control policy every product in the manufacturing plant is able to make its own decision at every time step during the manufacturing process, depending on the defined optimization goal.

As already stated, in FIG. 1, a Training concept of the RL agent in a virtual level (simulation) and application of the trained model at the physical level (real FMS) are shown.

As modules may be replaced by various manufacturing processes, this concept is transferable to any intra-plant logistics application.

If, in some cases, there is a situation which is not known to the system (e.g., when there is a new manufacturing module), the system is able to explore the actions in this situation and learn online how the actions perform. So, the system learns the best actions for unknown situations online, though it will likely choose suboptimal decisions in the beginning. Alternatively, there is the possibility to train the system in the training setup again with the adapted plant topology by using the GUI.

An important act in this disclosure is the representation of the FMS as a state matrix automatically. Therefore, a GUI is used, where the plant operator depicts the plant schematically and with very little engineering effort. An example GUI is shown in FIG. 3. There are boxes for modular and static production modules and thin boxes which represent conveyor belt sections. Decision making points have to be placed at desired positions. Behind the GUI, there are fixed and generic rules implemented, such as the fact that at the decision making points a decision needs to be made and the products may move on the conveyor belt from one decision making point to the next one after a decision is made.

The maximum number of products at one time in the plant, the maximum number of jobs in one job-list, and all possible jobs of the job-list, as well as the properties of the modules (including available executable jobs or maximum queue length) may be set in the GUI easily. Actions may be set as well, but at a decision point with various directions an action on default is choosing direction. When there is a decision point in front of a module and there is no conveyor belt leading into the module, the action “step into” may be set. With this schematic drawing of the plant and with the fixed knowledge of the meaning of the input, it is possible to automatically generate a simple simulation of the plant that is sufficient for training with the products moving from one decision point to the next one.

Various Products may be manufactured optimally in one FMS using different optimization goals at the same time.

Find the optimal way for a product through the FMS automatically by interacting with the simulated environment without the need for programming (self-training system).

The simulation is generated automatically from the GUI, there is no high engineering effort to generate a GUI for the training.

The representation of the current state of the FMS is generated automatically from the GUI, so there is no high effort to engineer the state description with only the important information from the FMS.

The decision making is not rule based or engineered. It is a self-learning system with less engineering effort.

The decision making takes place online and in near real-time as the solution is known for every situation from the training.

If, in some cases, there is a situation which is not known to the system (e.g., when there is a new manufacturing module), the system is able to explore the actions in this situation and learn online how the actions perform. So, the system learns the best actions for unknown situations online, though it will likely choose suboptimal decisions in the beginning. Alternatively, there is the possibility to train the system in the training setup again with adapted plant topology by using the GUI.

There is no need for communication between the products, as the information about the current state includes the modules' queues and therefore the important product positions.

No labelled data is needed the system to find the best decisions as it is trained by interacting with the simulation.

The Concept is transferable to any intra-plant logistics application.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for self-learning manufacturing scheduling for a flexible manufacturing system used to produce at least one product, wherein the flexible manufacturing system includes processing entities interconnected through handling entities, the method comprising:
learning a manufacturing scheduling by a reinforcement learning system on a model of the flexible manufacturing system, wherein the model represents at least a behavior and a decision making of the flexible manufacturing system; and
transforming the model in a state matrix to simulate a state of the flexible manufacturing system.

2. The method of claim 1, wherein one state of the state matrix represents one situation in the flexible manufacturing system including the at least one product.

3. The method of claim 1, wherein the flexible manufacturing system comprises a known topology, and the state matrix is generated that corresponds to information from the model, and
wherein a position of information in the state matrix is ordered accordingly to a topology of the flexible manufacturing system.

4. The method of claim 3, wherein the information in the state matrix is generated automatically,
wherein information of the handling entities is placed in the matrix according to an actual position in the flexible manufacturing system, and
wherein information of the processing entities is also placed.

5. The method of claim 3, wherein the information in the state matrix regarding the processing entities contains a representation of processing abilities of the respective entities.

6. The method of claim 3, wherein a body of the state matrix contains an input for every product of the at least one product that is located in the flexible manufacturing system at one point of time waiting in a processing queue for a processing entity.

7. The method of claim 3, wherein a body of the state matrix contains an input for a Job list.

8. The method of claim 3, wherein, for training of the reinforcement learning system, the information contained in the state matrix is used by calculating a next transition state of the state matrix containing all status information about the flexible manufacturing system at one time, that is used as input information for the reinforcement learning system as a basis for choosing a next transition to a next step at a time of the reinforcement learning system based on additionally entered and prioritized optimization criteria regarding the manufacturing process of the at least one product or an efficiency of the flexible manufacturing system.

9. The method of claim 1, wherein, for training of the reinforcement learning system, an initial state of the matrix shows a full Job list and a defined product location, and
wherein a termination state is characterized by an empty Job list.

10. A reinforcement learning system for self-learning manufacturing scheduling for a flexible manufacturing system configured to produce at least a product, wherein the flexible manufacturing system comprises processing entities interconnected through handling entities, the reinforcement learning system comprising:
a model of the flexible manufacturing system,
wherein the model represents at least a behavior and a decision making of the flexible manufacturing system,
wherein the model is realized as a state matrix,
wherein a manufacturing scheduling is configured to be learned by the reinforcement learning system on the model of the flexible manufacturing system, and
wherein the model is configured to be transformed in the state matrix to simulate a state of the flexible manufacturing system.

11. The method of claim 1, wherein information in the state matrix is generated automatically,
wherein information of the handling entities is placed in the matrix according to an actual position in the flexible manufacturing system, and
wherein information of the processing entities is also placed.

12. The method of claim 1, wherein information in the state matrix regarding the processing entities contains a representation of processing abilities of the respective entities.

13. The method of claim 1, wherein a body of the state matrix contains an input for every product of the at least one product that is located in the flexible manufacturing system at one point of time waiting in a processing queue for a processing entity.

14. The method of claim 13, wherein a respective input for every product is for a respective Job list.

15. The method of claim 1, wherein a body of the state matrix contains an input for a Job list.

16. The method of claim 1, wherein, for training of the reinforcement learning system, wherein information contained in the state matrix is used by calculating a next transition state of the state matrix containing all status information about the flexible manufacturing system at one time, that is used as input information for the reinforcement learning system as a basis for choosing a next transition to a next step at a time of the reinforcement learning system based on additionally entered and prioritized optimization criteria regarding the manufacturing process of the at least one product or an efficiency of the flexible manufacturing system.
